(19) United States
(12) Patent Application Publication
(10) Pub. No.: US 2007/0293404 A1
(43) Pub. Date: Dec. 20, 2007

(54) Subterranean Treatment Methods using Methanol Containing Foams

(76) Inventors: Richard D. Hutchins, Sugar Land, TX (US); Stanley B. McConnell, Katy, TX (US)

Correspondence Address: SCHLUMBERGER TECHNOLOGY CORPORATION;David Cate, IP DEPT., WELL STIMULATION, 110 SCHLUMBERGER DRIVE, MD1, SUGAR LAND, TX, 77478, US

(21) Appl. No.: 11/424,449

(22) Filed: Jun. 15, 2006

(51) Int. Cl. C09K 8/00; E21B 43/00

(52) U.S. Cl. 507/211; 507/110

(57) ABSTRACT

Methods using foamed fluids to perform subterranean formation treatments, the fluid containing methanol having a decreased concentration of gelling agent, while retaining excellent rheological properties in the foamed state, and processes for preparing foamed fluid for use in treating subterranean formations.

### FIELD OF THE INVENTION

The invention relates generally to fracturing fluids useful for subterranean formation fracturing, and methods for their use. In particular, the invention is methods of treating a subterranean formation penetrated by a wellbore utilizing foamed fluids.

### BACKGROUND

Fracturing fluids are used extensively in the oil and gas industry for hydraulic fracturing of subterranean rock formations. The fracturing fluid not only communicates the fracturing pressure to the formation, but can also be designed to carry proppant particles for delivery into the resulting fractures to prop them open after the fracturing pressure is relieved. This permits the formation to release fossil fuel more efficiently.

In order have adequate viscosity properties to fracture a subterranean formation, as well as to suspend proppant particles and to maintain them in suspension during the process, fracturing fluids typically contain a gelling agent. The fracturing fluid is typically pumped into the formation at a high rate and high pressure is applied. The pressure forces the rock formation to fracture, thereby allowing subsequent proppant-carrying fluid to enter and fill the resulting fracture. At this point in the process, the viscosity of the fluid is sufficiently high that the proppant does not settle out of the fluid. The pressure is then decreased to permit the fracture to close onto the proppant-carrying fluid. Typically, the gel is removed at that time to avoid the risk that it could block the pores and thereby decrease oil or gas production. Thus, to complete the process, the gel polymers, or at least the cross-links in a cross-linked gel, may be degraded chemically, enzymatically, and/or thermally, by a breaking agent, and the degraded fluid flushed from the formation back to the surface, leaving proppant in place in the fracture. The breaking agent can be a slow-acting agent that has been acting internally within the fracturing fluid throughout the fracturing process or it can be a delayed-acting agent, such as an encapsulated agent within the fluid that acts only upon release from encapsulation.

In order to reduce the amount of viscosity-increasing gelling agent injected into a formation, while increasing the distribution and rate of application of the fracturing fluid to the formation, foam fracturing processes have been developed in which a foamable fracturing fluid is formed that contains both a gelling agent and a foaming agent. Typically, the gelling agent, liquid base, and the foaming agent base are combined, and then mixed with other requisite components such as proppant particles, gel breakers, etc., and the resulting mixture is pumped to the well bore. Gas is then injected on-the-fly, commonly in the wellbore, into the mixture to produce a foam that is delivered to the formation. The formation is fractured and then, after the gel breaker has had sufficient time to break the gel and thereby reduce the viscosity of the foam, i.e. by decreasing the viscosity of the liquid phase, a valve is opened at the wellhead so that pressure from the injected gas blows much or most of the fluid back out to the surface, leaving proppant in the fracture.

It is desirable for the foam to be sufficiently stable that it does not break down so as to lose viscosity until it has effected fracturing and delivered proppant; for this reason a foaming agent is present in the fracturing fluid, the gel breaker is typically a delayed-action breaker, and a gel stabilizing agent that prevents high-temperature oxidation of the gelling agent is often included. The stability of the foam prior to action of the breaker, thus depends on the effectiveness of the foaming agent and the behavior of the gel components (the gelling agent and, where present, the cross-linking agent and/or gel stabilizer) under conditions of use.

It is desirable for foamed fracturing fluids to be a foam of relatively high density so as to effectively communicate pressure to the rock formation, while minimizing the amount of gelling agent delivered to the resulting fracture. In many applications, it is also desirable to include a volatile liquid, such as methanol, in the liquid base of the fluid to increase the proportion of fracturing fluid removed from the formation after fracturing, to function as a surfactant, as a clay stabilizer, and/or to decrease the amount of water included in the fluid. The presence of excess water can lead to water-block by saturating the formation so that hydrocarbon flow is impeded, and water can be absorbed by clays in the formation to cause clay swelling and/or migration, and other deleterious effects. In some cases, a clay stabilizer, such as ammonium or potassium chloride, is included in the fracturing fluid to decrease the effect of clay swelling.

It is known that methanol may cause foam instability. In some instances, to help overcome stability concerns, the foam is formed downhole at treatment zone depths by introducing a liquid base and a gas component separately into the wellbore, and mixing the two proximate the treatment zone. This approach allows more time for treatment before the foam destabilizes, but is a complicated and expensive approach.

Yet, in light of these fracturing fluid design factors, many foaming agents exhibit reduced effectiveness in the presence of methanol and/or clay stabilizers, and would not permit the concentration of gelling agent to be decreased, as the foam properties would be negatively impacted. As a result, it would be advantageous in the art to provide a foamed fracturing fluid which are a stable in the presence of methanol and/or clay stabilizers, yet that also contains a decreased concentration of gelling agent.

### SUMMARY OF INVENTION

The present invention provides subterranean formation treatment methods using foamed fracturing fluids which are stable in the presence of methanol and/or clay stabilizers, while containing a decreased concentration of gelling agent.

Treatment methods of the invention use foamed fracturing fluids containing a combination of a liquid phase comprising an aqueous medium, methanol that provides less than 25% by volume based on total fluid volume; at least about 10 and less than about 30 pounds per thousand gallons of liquid phase of a water-dispersible nonionic hydroxyalkyl galactomannan or substituted hydroxyalkyl galactomannan polymer as gelling agent; about 1 to about 10 gallons per thousand gallons liquid phase of an amphoteric surfactant foaming agent; and the liquid phase is combined with a gas component, to form a foam or energized fluid (either referred to as “foam” for purposes herein). The different components forming the foam are preferably mixed prior to injection downhole, as compared with a downhole mixed composite fracturing fluid. Also, about 1 to about 15% by weight based upon total liquid phase based weight of an optional gel stabilizer may be included.

In some embodiments, the foamed fracturing fluids are formed from a liquid phase that contains about 20 pounds per thousand gallons of the polymer (gelling agent), where the foamed fracturing fluids contain a polymer which is hydroxypropyl guar. Also, the methanol concentration is from about 1% to about 15% by volume based upon total liquid phase volume, and a foam forming amphoteric surfactant is present in an amount of about 5 gallons per thousand. Such foamed fracturing fluids that further contain one or more of a gel crosslinking agent, a gel breaker, or a proppant;

In other embodiments, the foamed fracturing fluids contain, and prepared by mixing prior to injection into the wellbore, about 50 to about 90% by volume, based upon total foam volume, of a gas component, and have a viscosity of greater than about 100 mPa-s, when measured in a dynamic rheometer under conditions of 200° F. and a shear of 100 sec⁻¹;

Processes for preparing foamed fracturing fluids include:

(1) providing a liquid phase which includes:
(a) a mixture of an aqueous medium and a sufficient concentration of methanol to provide a final concentration of at least 0.1% and less than 25% of methanol by volume, based upon total liquid phase volume;
(b) providing a water-dispersible nonionic hydroxyalkyl galactomannan or substituted hydroxyalkyl galactomannan polymer as gelling agent, in an amount sufficient to provide a final concentration of at least about 10 and less than about 30 pounds per thousand gallons fracturing fluid;
(c) providing an amphoteric surfactant as foaming agent, in an amount sufficient to provide a final concentration of from about 1 to about 10 gallons per thousand gallons liquid phase;

(2) providing a gas component; and,

(3) combining the liquid phase and the component prior to injection into a wellbore.

Some processes that further involve providing a gel breaker and combining the breaker with the mixture to form a breaker-containing foamed fracturing fluid. Also, processes may further involve providing a proppant and combining the proppant with the mixture to form a proppant-containing foamed fracturing fluid

Some methods of the invention are methods for hydraulically fracturing a subterranean formation, comprising injecting such a foamed fracturing fluid via a wellbore into a subterranean formation at a flow rate and pressure sufficient to produce or extend a fracture in the formation.

Some other methods of the invention are treatments other than hydraulic fracturing treatments, including clean-up operations, gravel packing operations, fluid loss control treatments, or acid diversion treatments.

Further areas of applicability will become apparent from the description provided herein. It should be understood that the description and specific examples are intended for purposes of illustration only and are not intended to limit the scope of the present disclosure.

### BRIEF DESCRIPTION OF DRAWINGS

The drawings described herein are for illustration purposes only and are not intended to limit the scope of the present disclosure in any way.

FIG. 1 presents a graph of foam viscosity versus time for three foam fracturing fluid formulations under dynamic conditions at 200° F. under a shear of 100 sec⁻¹ and a pressure of from about 1400 to about 1700 psi; the foams contain methanol and clay stabilizers, and each of the three samples contains a different concentration of hydroxypropyl guar gelling agent as follows: ( [symbol] ) 40 pounds per thousand gallons (top curve); ( [symbol] ) 30 pounds per thousand gallons (middle curve); and ( [symbol] ) 20 pounds per thousand gallons (bottom curve).

### DETAILED DESCRIPTION

The description and examples are presented solely for the purpose of illustrating the preferred embodiments of the invention and should not be construed as a limitation to the scope and applicability of the invention. While the compositions of the present invention are described herein as comprising certain materials, it should be understood that the composition could optionally comprise two or more chemically different materials. In addition, the composition can also comprise some components others than the ones already cited. In the summary of the invention and this detailed description, each numerical value should be read once as modified by the term “about” (unless already expressly so modified), and then read again as not so modified unless otherwise indicated in context.

The invention relates subterranean formation treatment methods using foamed fracturing fluids which are stable in the presence of methanol and/or clay stabilizers, while containing a decreased concentration of gelling agent. As used herein, the term “liquid phase” is meant to include all components of the fluid except a gas phase. The term “gas” is used herein to describe any fluid in a gaseous state or in a supercritical state, wherein the gaseous state refers to any state for which the temperature of the fluid is below its critical temperature and the pressure of the fluid is below its vapor pressure, and the supercritical state refers to any state for which the temperature of the fluid is above its critical temperature. As used herein, unless indicated otherwise or clear from the context, the terms “energized fluid”, “foam” and “fluid” are used interchangeably to describe any mixture of gas component and liquid phase, including foams, notwithstanding the foam quality value, i.e. the ratio of gas volume to the total volume of gas component and liquid phases. As used herein, the term “liquid phase” means that portion of the treatment fluids other than the gas component, and may also include solid material. The term “liquid base” is used to describe the aqueous-methanol medium to which other ingredients are added to form the liquid phase. The liquid phase may be substantially an aqueous, or may be an emulsion or microemulsion or oil and water.

Foamed fracturing fluids used according to embodiments of the present invention contain a liquid phase and a gas component. The liquid phase general contains a mixture of an aqueous medium and methanol, a galactomannan polymer as gelling agent, an amphoteric surfactant as a foaming agent, and can also include a high temperature gel stabilizer, a gel crosslinking agent, a gel breaking agent, as well as other components, e.g., a clay stabilizer. Proppant particles can be added thereto to form a slurry and the fracturing fluid or slurry can be injected with a gas to form a foam that is pumped into a subterranean formation. These components can be combined in various orders, although in some embodiments hereof, the breaking agent and/or foaming agent can be added on-the-fly, just prior to injection of the gas component.

As used herein, the term “fracturing fluid” refers to the fluid without proppant. The “fracturing fluid” can be mixed with a proppant to form a “fracturing fluid slurry.” Either the fracturing fluid or the slurry can be combined with a gas to form a foam, the former being a proppant-free foam and the latter being a proppant-containing foam.

Foamed fracturing fluids used accordingly with method embodiments of the invention surprisingly retain substantial Theological properties, in spite of the reduced concentration of gelling agent and the presence of methanol and, optionally, of clay stabilizer(s). Thus, as one nonlimiting example, a fracturing fluid hereof containing about 20 pounds per thousand gallons of fluid is capable, upon foaming, of retaining a viscosity of great than 100 mPa-s for at least 2 hours, and typically for at least 2.5 hours, which is a sufficient time to permit a treatment operation, such as fracturing, and recovery operation to proceed. Similarly, such a 20 pounds per thousand gallons formulation hereof, can exhibit good clean-up once treatment has been conducted.

While the compositions hereof have been described as “comprising” various components, they can also be formulated to consist essentially of or consist of the various components.

### Gel Components

Galactomannan Polymer Gelling Agent. In various method embodiments, a fracturing fluid is used in accordance with the invention that contains a gelling agent that is preferably a water-dispersible, linear, nonionic, hydroxyalkyl galactomannan polymer or a substituted hydroxyalkyl galactomannan polymer. Examples of useful hydroxyalkyl galactomannan polymers include, but are not limited to, hydroxy-C1-C4-alkyl galactomannans, such as hydroxy-C1-C4-alkyl guars. Preferred examples of such hydroxyalkyl guars include hydroxyethyl guar (HE guar), hydroxypropyl guar (HP guar), and hydroxybutyl guar (HB guar), and mixed C2-C4, C2/C3, C3/C4, or C2/C14 hydroxyalkyl guars. Hydroxymethyl groups can also be present in any of these.

As used herein, substituted hydroxyalkyl galactomannan polymers are obtainable as substituted derivatives of the hydroxy-C1-C4-alkyl galactomannans, which include: 1) hydrophobically-modified hydroxyalkyl galactomannans, e.g., C1-C18-alkyl-substituted hydroxyalkyl galactomannans, e.g., wherein the amount of alkyl substituent groups is preferably about 2% by weight or less of the hydroxyalkyl galactomannan; and 2) poly(oxyalkylene)-grafted galactomannans (see, e.g., A. Bahamdan & W. H. Daly, in Proc. 8^{th} Polymers for Adv. Technol. Int'l Symp. (Budapest, Hungary, September 2005) (PEG- and/or PPG-grafting is illustrated, although applied therein to carboxymethyl guar, rather than directly to a galactomannan)). Poly(oxyalkylene)-grafts thereof can comprise two or more than two oxyalkylene residues; and the oxyalkylene residues can be C1-C4 oxyalkylenes. Mixed-substitution polymers comprising alkyl substituent groups and poly(oxyalkylene) substituent groups on the hydroxyalkyl galactomannan are also useful herein. In various embodiments of substituted hydroxyalkyl galactomannans, the ratio of alkyl and/or poly(oxyalkylene) substituent groups to mannosyl backbone residues can be about 1:25 or less, i.e. with at least one substituent per hydroxyalkyl galactomannan molecule; the ratio can be: at least or about 1:2000, 1:500, 1:100, or 1:50; or up to or about 1:50, 1:40, 1:35, or 1:30. Combinations of galactomannan polymers according to the present disclosure can also be used.

As used herein, galactomannans comprise a polymannose backbone attached to galactose branches that are present at an average ratio of from 1:1 to 1:5 galactose branches:mannose residues. Preferred galactomannans comprise a 1→4-linked β-D-mannopyranose backbone that is 1→6-linked to α-D-galactopyranose branches. Galactose branches can comprise from 1 to about 5 galactosyl residues; in various embodiments, the average branch length can be from 1 to 2, or from 1 to about 1.5 residues. Preferred branches are monogalactosyl branches. In various embodiments, the ratio of galactose branches to backbone mannose residues can be, approximately, from 1:1 to 1:3, from 1:1.5 to 1:2.5, or from 1:1.5 to 1:2, on average. In various embodiments, the galactomannan can have a linear polymannose backbone. The galactomannan can be natural or synthetic. Natural galactomannans useful herein include plant and microbial (e.g., fungal) galactomannans, among which plant galactomannans are preferred. In various embodiments, legume seed galactomannans can be used, examples of which include, but are not limited to: tara gum (e.g., from Cesalpinia spinosa seeds) and guar gum (e.g., from Cyamopsis tetragonoloba seeds). In addition, although embodiments of the present invention may be described or exemplified with reference to guar, such as by reference to hydroxy-C1-C4-alkyl guars, such descriptions apply equally to other galactomannas, as well.

In fracturing fluids used according to the invention, the linear galactomannan polymer is present at a concentration that is significantly less than the industry standard of from about 30 to about 40 pounds per thousand gallons of the liquid phase to avoid damage to the wellbore, the concentration being less than about 30 pounds per thousand gallons of the liquid phase. In various embodiments hereof, the gelling agent can be present in an amount of from about 10 to less than about 30 pounds per thousand gallons, or from about 15 to less than about 30 pounds per thousand gallons, or from about 15 to about 25 pounds per thousand gallons, or even from about 17 to about 22 pounds per thousand gallons. Generally, the gelling agent can be present in an amount of from about 10 to less than about 30 pounds per thousand gallons of liquid phase, with a lower limit of polymer being no less than about 10, 11, 12, 13, 14, 15, 16, 17, 18, or 19 pounds per thousand gallons of the liquid phase, and the upper limited being less than about 30 pounds per thousand gallons, no greater than 29, 28, 27, 26, 25, 24, 23, 22, 21, or 20 pounds per thousand gallons of the liquid phase. In some embodiments, the polymers can be present in an amount of about 20 pounds per thousand gallons. Hydroxypropyl guar is a preferred polymer for use herein as a gelling agent.

Gel Crosslinking Agent. In various embodiments, a fracturing fluid according to the present invention contains a gel crosslinking agent. The crosslinking agent can be any known in the art, such as the commonly used salts and compounds providing aluminum, titanium, zirconium, or antimony cations, or borate anions (including, e.g., delayed action crosslinkers, such as boric acid-glyoxal systems or zirconium-polyol complexes and zirconium-organic acid complexes), are commonly used as crosslinkers. In various embodiments, the crosslinking agent can be present in an amount sufficient to provide from about 0.02 to about 0.2 moles of ion per pound of polymer for zirconium, titanium, aluminum, antimony based crosslinkers; and preferably at least or about 0.0005 to 0.01 moles of boron ion per pound of polymer.

### Gel Stabilizer

Various gel stabilizers known in the art are useful in embodiments hereof, by virtue of their antioxidant effect. A gel stabilizer prolongs the life of the polymer (e.g., polysaccharide) by counteracting oxygen species in the fluid that, under high temperature and operating pressure, would otherwise oxidatively degrade the gel-forming polymer. Preferred high temperature gel stabilizers for use in various embodiments according to the present invention include alkali metal salts of thiosulfate, such as sodium thiosulfate. In various embodiments, the gel stabilizer can be present in an amount of from 1 to about 15% by weight in the fracturing fluid; or about or at least 2% or 3% or 5% or 10%, and up to about 15%. In some embodiments, the gel stabilizers used are compounds with contain amine functional groups.

### Gel Breaker

In various embodiments, a composition used in accordance with the invention can contain a gel breaker. Any of the various gel breakers known in the art as useful for degradation of galactomannan polymers can be used, and these include oxidative, acid, and enzymatic breakers. Encapsulated breakers are preferred. The breakers are typically incorporated in an amount of from about 1 to about 40 pounds per thousand gallons of liquid phase, preferably from about 2 to about 10 pounds per thousand gallons of liquid phase.

### Foaming Agent

In various embodiments, a fracturing fluid according to the present invention can contain a foaming agent that is an amphoteric surfactant. One example of a suitable amphoteric surfactant is the amphoteric alkyl amine solution known under the tradename AQUET® 944, available from Baker Petrolite (Sugar Land, Tex.). Other nonlimiting examples of effective amphoteric surfactant are alkyl dimethyl betaines, alkyl amidopropyldimethyl betaines, alkyl dimethyl sulfobetaines or alkyl amidopropyidimethyl sulfobetaines, such as MIRATAINE® CBS, sold by the company Rhodia, The foaming agent can be present in the fracturing fluid in an amount from about 1 to about 10 gallons per thousand gallons of fluid, or preferably from about 2 to about 8, or from about 4 to about 6, or about 5 gallons per thousand. The foaming agent can be added on-the-fly, e.g., at about the same time as the breaker, just prior to injection of the foaming gas.

### Liquid Base

In various embodiments according to the present invention, a liquid phase uses a liquid base to disperse and/or solvate the components of the fracturing fluid. The liquid base can be aqueous methanol, wherein a total of 25% or less by volume methanol is provided to the fracturing fluid. The liquid base can provide about 0.1 to about 20%, or about 1 to about 15% of methanol to the fracturing fluid. (The final concentration of methanol in the fracturing fluid is about 25% or less by volume.) The methanol makes up at least 0.1% v/v of the fracturing fluid. In various embodiments, the methanol can make up: about or less than 25%, 24%, 23%, 22%, 21%, 20%, 19%, 18%, 17%, 16%, 15%, 10%, or 5%; or at least or about 1%, 2%, 3%, 4%, 5%, 6%, 7%, 8%, 9%, 10%, 15%, or 20% by volume, based on total volume of the liquid phase. The aqueous component of the liquid based can be provided, e.g., by purified water, open water sources, or seawater.

### Proppant

Fluids useful in methods of the invention may also include proppant particles that are substantially insoluble in the fluids of the formation. Proppant particles carried by the treatment fluid remain in the fracture created, thus propping open the fracture when the fracturing pressure is released and the well is put into production. Suitable proppant materials include, but are not limited to, sand, walnut shells, sintered bauxite, glass beads, ceramic materials, naturally occurring materials, or similar materials. Mixtures of proppants can be used as well. If sand is used, it will typically be from about 20 to about 100 U.S. Standard Mesh in size. Naturally occurring materials may be underived and/or unprocessed naturally occurring materials, as well as materials based on naturally occurring materials that have been processed and/or derived. Suitable examples of naturally occurring particulate materials for use as proppants include, but are not necessarily limited to: ground or crushed shells of nuts such as walnut, coconut, pecan, almond, ivory nut, brazil nut, etc.; ground or crushed seed shells (including fruit pits) of seeds of fruits such as plum, olive, peach, cherry, apricot, etc.; ground or crushed seed shells of other plants such as maize (e.g., corn cobs or corn kernels), etc.; processed wood materials such as those derived from woods such as oak, hickory, walnut, poplar, mahogany, etc. including such woods that have been processed by grinding, chipping, or other form of particalization, processing, etc. Further information on nuts and composition thereof may be found in Encyclopedia of Chemical Technology, Edited by Raymond E. Kirk and Donald F. Othmer, Third Edition, John Wiley & Sons, Volume 16, pages 248-273 (entitled “Nuts”), Copyright 1981, which is incorporated herein by reference.

The concentration of proppant in the fluid can be any concentration known in the art, and will preferably be in the range of from about 0.05 to about 3 kilograms of proppant added per liter of liquid phase. Also, any of the proppant particles can further be coated with a resin to potentially improve the strength, clustering ability, and flow back properties of the proppant.

### Gas Component

Foaming gas, or gas component, as used herein refers to pure gases and gas mixtures, such as CO₂, N₂, air, inert gases, and combinations thereof that can be used to foam the fracturing fluid or slurry without chemically reacting with the components thereof in a manner that degrades the properties thereof. The foam can contain the gas in an amount from about 50% to about 90% by volume of the foam composition, more typically about 60 to about 80%, or about 70 to about 75%. Preferred gases include CO₂ and N₂. The gas component may be supplied in any suitable state. For example, CO₂ may be supplied in a compressed gaseous or supercritical fluid state.

### Other Additives

Clay Stabilizer. In various embodiments, a clay stabilizer can be further included in compositions used in accordance with the invention. Any of the various clay stabilizers known in the art can be used, including transient stabilizers and that so-called “permanent” stabilizers that provide long-term stabilization. A clay stabilizer can comprise any one of potassium or ammonium chloride, a quaternary alkylammonium halide, a cationic polymer (e.g., such as polyethyleneimine), or a combination thereof. Useful quaternary alkylammonium halides include those where the alkyl groups are any of the C1-C12, or any of the C1-C6 or C1-C4 alkyl groups. Examples of these quaternary alkylammonium halides include triethylmethylammonium chloride, tetraethylammonium chloride, and the like. In various embodiments, a solid clay stabilizer can be present in an amount from about 0.1 to about 7% by weight of the liquid phase; preferably about 0.5 to about 3%, or about 1 to about 2.5%, or about 2%. In various embodiments, a liquid clay stabilizer can be present in an amount from about 0.1 to about 5 gallons per thousand gallons of liquid phase; preferably about 0.5 to about 3 gpt, or about 1 to about 2.5 gpt, or about 2 gpt.

Others. The fluids used in the invention include an electrolyte which may be an organic acid, organic acid salt, inorganic salt or a polyelectrolyte. Use of mixtures of the above members is specifically contemplated as falling within the scope of the invention. This member will typically be present in a minor amount (e.g. less than about 30% by weight of the liquid phase).

The organic acid is typically a sulfonic acid or a carboxylic acid, and the anionic counter-ion of the organic acid salts is typically a sulfonate or a carboxylate. Representative of such organic molecules include various aromatic sulfonates and carboxylates such as p-toluene sulfonate, naphthalene sulfonate, chlorobenzoic acid, salicylic acid, phthalic acid and the like, where such counter-ions are water-soluble. Most preferred organic acids are formic acid, citric acid, 5-hydroxy-1-napthoic acid, 6-hydroxy-1-napthoic acid, 7-hydroxy-1-napthoic acid, 1-hydroxy-2-naphthoic acid, 3-hydroxy-2-naphthoic acid, 5-hydroxy-2-naphthoic acid, 7-hydroxy-2-napthoic acid, 1,3-dihydroxy-2-naphthoic acid, and 3,4-dichlorobenzoic acid.

The inorganic salts that are particularly suitable include, but are not limited to, water-soluble potassium, sodium, and ammonium salts, such as potassium chloride and ammonium chloride. Additionally, magnesium chloride, calcium chloride, calcium bromide, zinc halide, sodium carbonate, and sodium bicarbonate salts may also be used. Any mixtures of the inorganic salts may be used as well. The inorganic salts may aid in the development of increased viscosity that is characteristic of preferred fluids. Further, the inorganic salt may assist in maintaining the stability of a geologic formation to which the fluid is exposed. Formation stability and in particular clay stability (by inhibiting hydration of the clay) is achieved at a concentration level of a few percent by weight and as such the density of fluid is not significantly altered by the presence of the inorganic salt unless fluid density becomes an important consideration, at which point, heavier inorganic salts may be used. In a preferred embodiment of the invention, the electrolyte is potassium chloride. The electrolyte is preferably used in an amount of from about 0.01 wt % to about 12.0 wt % of the total liquid phase weight, and more preferably from about 1.0 wt % to about 8.0 wt % of the total liquid phase weight.

Aqueous fluids used in embodiments of the invention may also comprise an organoamino compound. Examples of suitable organoamino compounds include, but are not necessarily limited to, tetraethylenepentamine, triethylenetetramine, pentaethylenhexamine, triethanolamine, and the like, or any mixtures thereof. When organoamino compounds are used in fluids of the invention, they are incorporated at an amount from about 0.01 wt % to about 2.0 wt % based on total liquid phase weight. Preferably, when used, the organoamino compound is incorporated at an amount from about 0.05 wt % to about 1.0 wt % based on total liquid phase weight. A particularly useful organoamino compound is tetraethylenepentamine.

### EXAMPLES

Three formulations of foamed fracturing fluid are prepared, without proppant, in order to test the foam rheology properties when the concentration of gelling agent is decreased. Each of the formulations contains, in a 25% by volume methanol/75% by volume water liquid base, 5 gallons per thousand, amphoteric alkyl amine foaming agent AQUET 944 from Baker Petrolite, Sugar Land, Tex., 1.7% by weight, based on total liquid phase weight, of potassium chloride clay stabilizer, 2 gallons per thousand gallons of liquid phase of a permanent clay stabilizer, DOWELL L55, and 70% N₂ gas by volume of foam. Each formulation contains a different concentration of hydroxypropyl guar (HPG). The first formulation contains 40 pounds HPG per thousand gallons (ppt) of liquid phase (unfoamed); the second contains 30 ppt HPG; and the third contains 20 ppt HPG.

The properties of these composition are assayed using a dynamic rheometer system having a heated loop design, that can assess foam properties at shear rates up to 200 sec⁻¹, temperatures up to 400° F., and pressures up to 3000 psi. The system includes a circulation pump, a foam generation mixer attached to a metered CO₂ or N₂ gas supply, a mass flow meter, and a loop of tubing that is maintained at temperature in an oven. During an assay, a 20 foot length of ¼-inch tubing is used and the flow rate of foam within the tubing is continuously adjusted, in order to ensure that a constant shear rate is being applied, in response to incoming mass flow meter data.

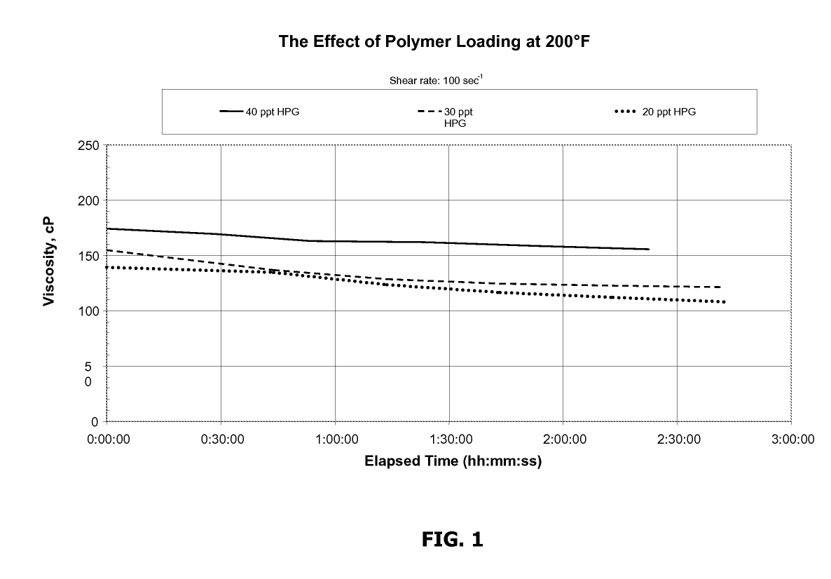

All three of the above formulations are tested under conditions of 200° F. under a shear of 100 sec⁻¹ and a nominal pressure of about 1500 psi. Viscosity results are presented in FIG. 1. The legend is as follows: [symbol] 40 ppt HPG; (top curve); [symbol] 30 ppt HPG (middle curve); and [symbol] 20 ppt HPG (bottom curve). These results surprisingly show that, even the 20 ppt HPG formulation retains a viscosity of greater than 100 cP for at least 2.5 hours, and exhibits, at least during the first 150 minutes post-foaming, an apparent foam half-life of at least 5.5 hours.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

What is claimed is:

1. A method for hydraulically fracturing a subterranean formation, comprising injecting into a subterranean formation at a flow rate and pressure sufficient to produce or extend a fracture in the formation, a foamed fracturing fluid formed of a gas component and a liquid phase, the liquid phase comprising:
(A) an aqueous medium comprising methanol in an amount of about 25% or less by volume, based upon total liquid phase;
(B) at least 10 and less than about 30 pounds per thousand gallons liquid phase of a gelling agent; and
(C) about 1 to about 10 gallons per thousand gallons fracturing fluid of an amphoteric surfactant.

2. The method according to claim 1, wherein the gelling agent is present in an amount of from about 15 to about 30 pounds per thousand gallons of liquid phase.

3. The method according to claim 1, wherein the gelling agent is present in an amount of from about 15 to about 25 pounds per thousand gallons of liquid phase.

4. The method according to claim 1, wherein the gelling agent is present in an amount of from about 17 to about 22 pounds per thousand gallons of liquid phase.

5. The method according to claim 1, wherein the gelling agent is present in an amount of about 20 pounds per thousand gallons of liquid phase.

6. The method according to claim 1, wherein the gelling agent is hydroxypropyl guar.

7. The method according to claim 1, wherein the aqueous medium comprises methanol in an amount from about 1% to about 20% by volume, based upon total liquid phase volume.

8. The method according to claim 1, wherein the amphoteric surfactant is present in an amount from about 2 to about 8 gallons per thousand gallons of liquid phase.

9. The fracturing fluid according to claim 1, wherein the amphoteric surfactant is present in an amount of about 5 gallons per thousand gallons of liquid phase.

10. The method according to claim 1, further comprising a sodium thiosulfate gel stabilizer in an amount of from about 5 to about 15% by weight, base upon total liquid phase weight.

11. The method according to claim 1, wherein the fluid further comprises a gel crosslinking agent.

12. The method according to claim 1, wherein the fluid further comprises a gel breaker.

13. The method according to claim 1, wherein the fluid further comprises a proppant.

14. The method according to claim 1, wherein the gas component is incorporated in an amount from about fracturing fluid according to claim 1, and about 50 to about 90% by volume, based upon total foam volume.

15. The method according to claim 14, wherein the foamed fracturing fluid retains, during at least the first 150 minutes after foam formation, a viscosity of greater than 100 cP and an apparent foam half-life of at least 5.5 hours, when measured in a dynamic rheometer under conditions of 200° F. and a shear of 100 sec⁻¹.

16. A method for treating a subterranean formation, comprising injecting into a subterranean formation at a flow rate and pressure sufficient to treat the formation, a foamed fluid formed of a gas component and a liquid phase, the liquid phase comprising:
(A) an aqueous medium comprising methanol in an amount of about 25% or less by volume, based upon total liquid phase;
(B) at least 10 and less than about 30 pounds per thousand gallons liquid phase of a gelling agent;
(C) about 1 to about 10 gallons per thousand gallons fracturing fluid of an amphoteric surfactant as foaming agent; and
(D) a gas component;
whereby the aqueous medium, the gelling agent, the surfactant, and the gas component are combined prior to injection into a wellbore penetrating the subterranean formation.

17. The method according to claim 16, wherein the treatment is a hydraulic fracturing treatment, clean-up operation, gravel packing operation, fluid loss control treatment, or acid diversion treatment.

18. A process for preparing a treatment composition comprising:
(A) providing the components of a foamed treatment fluid, the fluid comprising:
(1) a liquid base comprising water and a sufficient concentration of methanol to provide a final concentration of at least 0.1% and less than 25% volume methanol, based upon total liquid phase volume of total liquid phase;
(2) a gelling agent, in an amount sufficient to provide a final concentration of at least 10 and less than 30 pounds per thousand gallons of total liquid phase;
(3) an amphoteric surfactant as foaming agent, in an amount sufficient to provide a final concentration of from about 1 to about 10 gallons per thousand gallons of total liquid phase; and
(4) a gas component;
(B) combining the liquid base with the polymer to form a mixture, and then
(C) prior to injection into a wellbore, combining the surfactant, gas component and the mixture (B) to form the foamed fluid.

19. The process according to claim 18, where the process further comprises providing a gel breaker in step (A), and combining the breaker with the mixture (B) either before or after the combining step (C), to form a breaker-containing foamed fluid.

20. The process according to claim 18, where the process further comprises providing a proppant in step (A), and combining the proppant with the mixture (B) either before or after the combining step (C), to form a proppant-containing foamed fluid.

21. The process according to claim 18, wherein the process further comprises providing a foaming gas in step (A), and injecting the foaming gas into the liquid base, the polymer, and the surfactant, in a sufficient quantity and at a sufficient rate to produce a foam having a final concentration of gas component of from about 50 to about 90% by volume of the foam.
